(19) United States
(12) Patent Application Publication
(10) Pub. No.: US 2002/0182297 A1
(43) Pub. Date: Dec. 5, 2002

(54) Food patty molding apparatus

(75) Inventors: Dennis L. Buhlke, Chino Hills, CA (US); Gary Cowart, McDonough, GA (US); Henry Araujo, Rancho Cucamonga, CA (US); Jack Clemens, Fontana, CA (US)

Correspondence Address: David J. Meyer, Manatt, Phelps & Phillips, LLP, 11355 West Olympic Boulevard, Los Angeles, CA, 90064, US

(73) Assignee: Golden State Foods Corp.

(21) Appl. No.: 10/152,294

(22) Filed: May 20, 2002

Related U.S. Application Data
(63) Continuation-in-part of application No. 09/650,343, filed on Aug. 28, 2000.
Application No. 09/650,343 is a continuation-in-part of application No. 09/561,120, filed on Apr. 28, 2000, now abandoned.

(51) Int. Cl. A01J 1/00

(52) U.S. Cl. 426/512

(57) ABSTRACT

An improved machine for forming food patties in which multiple rows of food patties are extruded into a mold plate through separate fill slots, enabling higher production rates and improved efficiency due to less waste of food material.

This application is a continuation-in-part of U.S. patent application Ser. Nos. 09/561,120, filed Apr. 28, 2000 and 09/650,343 filed Aug. 28, 2000.

The apparatus of the present invention doubles the output of existing equipment. Indeed, one of the principal advantages of the invention is that it may be implemented on existing equipment with a relatively modest change in tooling. In preferred embodiments of the invention, 12 food patties are prepared in the course of a single machine cycle. A further advantage of the invention is that it is capable of providing significantly increased output of food patties at reduced operating speeds, and with higher yields.

### BACKGROUND OF THE INVENTION

Food patties are used in a variety of different food products. Ground meat patties are used in particularly high volume by fast food restaurants. In view of the high demand for ground meat patties, increasing the rate at which food patties are produced is an objective of the food processing industry. A further objective is to improve the rate of production of food patties without incurring the cost of new equipment These objectives are met by the invention disclosed and claimed herein.

In existing high speed production equipment, ground food material is extruded under pressure through a single continuous slot that spans nearly the entire mold plate. In such machines, typically six patty cavities are filled simultaneously in the course of each machine cycle. A drawback of prior art equipment is that there is food because food material is extruded into areas of mold plates between patty cavities. Although attempts have been made to recycle such food material, some is inevitably lost.

A number of inventions have attempted to address the deficiencies of prior art equipment used for food patty preparation. For example, Holly, U.S. Pat. Nos. 3,747,160, 3,750,232 and 3,765,056 refers to food patty molding apparatus including a sliding plate comprising mold openings. However, the machines are generally small, and incapable of high speed production of food patties.

Sandberg et al., U.S. Pat. Nos. 4,054, 967; 4,356,595 and 4,821,376 refers to large high speed machines for production of food patties but does not teach or suggest improvements in the rate at which food patties may be formed. Richards, U.S. Pat. No. 3,887,964 refers broadly to modification of a mold plate, but fails to make any suggestions of what modifications may be made.

In general, prior art patty forming equipment employs a fill plate through which food material is extruded. For example Richards, U.S. Pat. No. 3,887,964, a representative example of a prior art design, refers to a single fill slot for extruding food material into patty forming cavities in a mold plate. A drawback of single slot fill plates is that food is pumped into areas of the mold plate between patty cavities. The present invention therefore represents an improvement on the prior art in using a discontinuous fill slot, in which openings in the fill plate correspond to patty cavities in the mold plate. More importantly, the present invention substantially increases the output of food patties by providing an enlarged mold plate, that is compatible with stock patty forming machines, that doubles the output of standard 1/10 pound patties, by forming multiple rows of food patties.

### SUMMARY OF THE INVENTION

The present invention overcomes the above mentioned deficiencies of the prior art. The invention relates to an improved apparatus for making food patties, such as hamburgers, as well as patties made from other sources of ground meat, such as pork and chicken and ground vegetable products. The invention includes improvements in tooling used with existing food processing equipment that allows food patties to be produced at a higher rate and with greater efficiency by relatively inexpensive modification of such existing equipment.

More specifically, the present invention relates to a mold plate comprising plural rows of cavities for forming food patties, a fill plate for use in conjunction with the mold plate to extrude food material into cavities of the mold plate, and a breather plate to exhaust gas trapped during extrusion, without deforming the food patties. The invention includes other modifications, discussed below.

In preferred embodiments of the invention, food material is extruded into patty cavities formed in a mold plate, by way of a fill plate. The presently preferred mold plate comprises two rows of six patty cavities. The mold plate reciprocates between loading and discharge positions so that in each cycle of the food patty forming machine, at least 12 patties can be formed. In operation the mold reciprocates between the fill plate, below, and breather plate above. The contacting surfaces of the respective surfaces are, accordingly smoothed to minimize friction. The dimensions of the mold plate and drive train are modified to accommodate an increase in stroke length of about one inch. Thus in presently preferred embodiments, the invention permits twice as many food patties to be formed in each machine cycle as compared with prior art food processing machines, with relatively minor modification of production equipment.

### BRIEF DESCRIPTION OF THE DRAWINGS

FIG. 1 is a composite drawing of the preferred breather plate, mold plate and fill plate, in sequence.

FIG. 2 is an enlarged drawing of the mold plate.

FIG. 3 is an enlarged drawing of the mold plate superimposed on the fill plate to show the relationship between the fill slots and patty cavities.

FIG. 4 shows the breather plate, mold plate and fill plate superimposed to show the relationships between the breather plate and patty cavities.

FIG. 5 shows an embodiment of the reciprocating assembly of the invention.

FIG. 6 is a summary of the timing and hydraulic pressure changes relative to the position of the mold plate in presently preferred embodiments of the invention.

### DETAILED DESCRIPTION OF THE INVENTION

In one aspect, the invention relates to improvements in equipment for forming food patties. More specifically, the improvement relates to modifications to the mold plate, fill plate and breather plates as well as the drive train of food patty molding equipment. In preferred embodiments the food patty molding equipment is the Formax 26 machine, manufactured by Formax, Inc. of Mokena Ill.

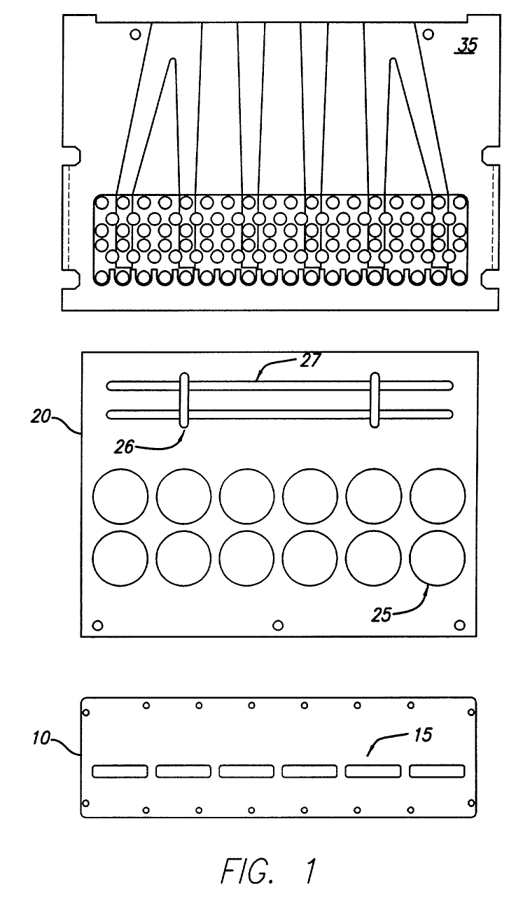

As illustrated in FIG. 1, the apparatus for forming food patties in accordance with the present invention comprises fill plate 10, mold plate 20, and breather plate 30. A mold cover, which is conventional, may also used be used.

The fill, mold and breather plates are arranged in a stack with fill plate 10 at the bottom of the stack, in the presently preferred embodiment. It should of course be born in mind that other arrangements, such as inverting the order in which the plates are arranged, is also within the scope of the invention. In the preferred embodiment, a mold cover is positioned atop breather plate 30.

Preferably, fill plate 10 is formed of stainless steel, as are other components of the inventive apparatus and is generally rectangular. Fill plate 10 is formed with rectangular slots (15) milled through it. In a preferred embodiment, the slots 15 may have rounded edges. In the presently preferred embodiment, the fill plate has six slots, aligned with one another, across the long dimension of the fill plate. In one embodiment of the invention, the fill slots are oriented at an acute angle with respect to the surface of the fill plate. In the presently preferred embodiment, the fill slots are oriented perpendicularly to the surface of the fill plate.

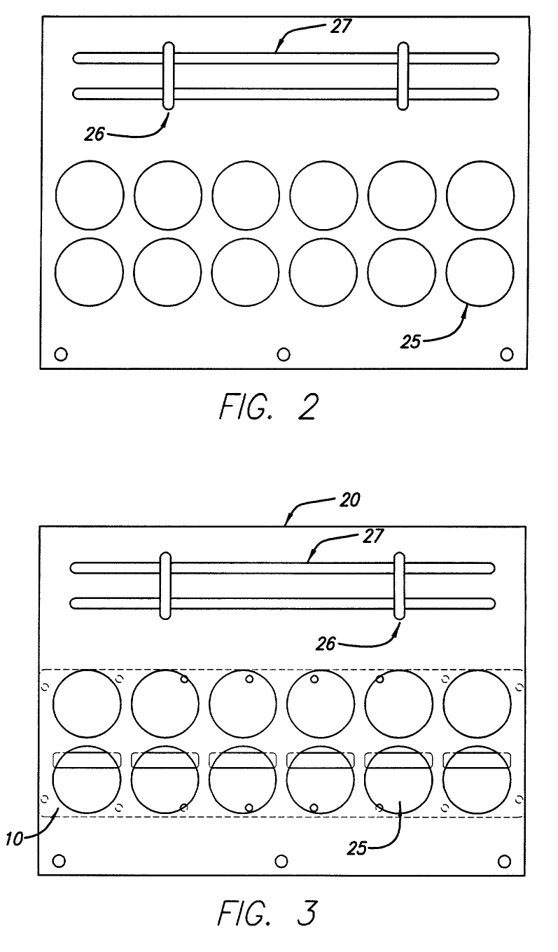

Mold plate 20 is rectangular in shape, though wider than fill plate 10. As shown in FIG. 2, mold plate 20 has two rows of generally circular conventional patty cavities. More rows may be added, but require lengthening of the mold plate and the throw of the reciprocating assembly that moves the mold plate.

As shown in FIGS. 1 and 3, the opening each of the fill slots of fill plate 10 are aligned with the openings of the patty cavities as shown in FIG. 3, which shows a mold plate drawn superimposed upon a fill plate. More specifically, and as will be described in greater detail below, the mold plate reciprocates between fill and discharge positions. At the same time, two rows of patty cavities are sequentially filled with food material as the mold plate moves over the openings of the fill slot.

In preferred embodiments, lubrication slots (26) oriented parallel to the shorter dimension of the mold plate are milled through the mold plate behind the rows of patty cavities. Food material such as ground meat provides continuous lubrication of the moving metal parts during operation of the patty forming apparatus; the excess food product is removed by way of the lubrication slots. In preferred embodiments, channels (27) are also formed in the upper surface of the mold plate to provide lubrication.

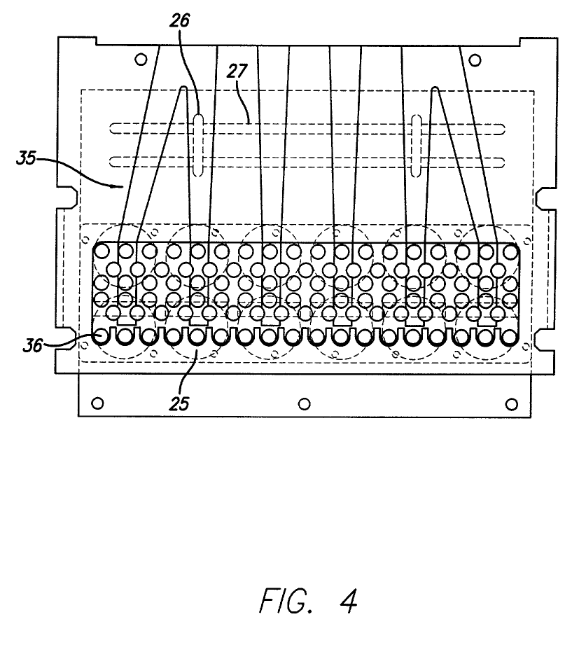

A breather plate is positioned atop the mold plate. The breather plate has openings—preferably perforations (36 in FIG. 4)—formed in its upper surface to exhaust gases formed by the operation of the patty forming apparatus. In preferred embodiments, the surface of the breather plate is formed with channels milled in its surface to direct excess food material away from the patty and back to the food pump apparatus.

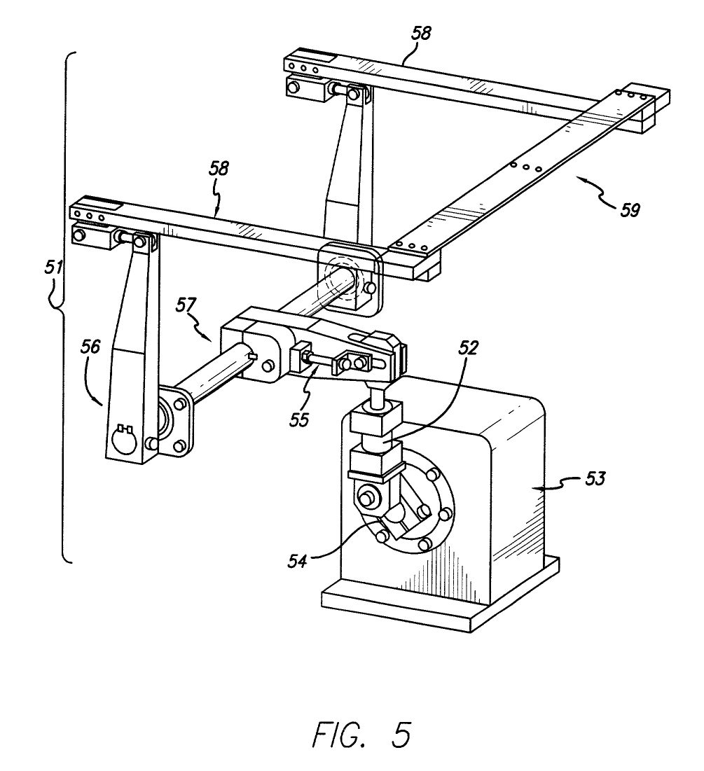

In operation, equipment modified in accord with the present invention to form food patties employs plungers operated by hydraulic cylinders and piston assemblies to extrude food material from slots in fill plate (10) through application of hydraulic pressure. A mold plate is moved back and forth in a horizontal plane between fill and discharge positions by a reciprocating assembly. The reciprocating assembly is described below with reference to FIG. 5.

In one embodiment the reciprocating assembly (51) includes a gear box (53), which rotates a crank arm (54). An embodiment of reciprocating assembly is shown in FIG. 5. The rotation of the crank arm results in linear displacement of a connector rod, 52. The connector rod is attached to a short arm (55) which is in turn attached to a rocker arm drive shaft (57). In the present invention, the adjustable length of short arm (55) is extended over that of the stock machine to accommodate the greater extent of mold plate (20). Linear movement of the connector rod causes the short rocker arm to pivot about the axis of the rocker arm drive shaft. The rocker arm drive shaft is in turn attached to a pair of mold plate drive arms (58). Rotation of the short arm about the axis of the rocker arm drive shaft causes the rocker arms (56) to reciprocate back and forth in a horizontal plane. A draw bar (59) facilitates attachment of the mold plate to the mold plate drive arms.

In a presently preferred embodiment the mold plate reciprocates between fill and discharge positions at about 65 cycles per minute. This rate can be varied however, using techniques well known in the food processing art. In the presently preferred embodiment, the mold plate reciprocates at approximately 80 cycles per minute, though greater rates of production are possible.

Also in the preferred embodiment of the invention, a smaller hydraulic cylinder is employed to move the plungers used to extrude food material, in order to achieve faster filling of the patty cavities. More specifically, the four inch hydraulic cylinders are preferably replaced by 3 ¼ inch cylinders.

In operation, fill plate 10 receives food material such as ground beef, under hydraulic pressure in excess of up to 400 psi from a food pump (not shown) which may be located beneath the fill plate. The food material thereafter enters patty cavities (25) through fill slots (15) in the fill plate. Continued application of hydraulic pressure forces food material into patty cavities (25) in the mold plate, while the mold plate is in a filling position.

The mold plate reciprocates between a filling and discharge positions. In contrast to prior art patty forming machines, and as described in more detail below, two rows of food patties are formed in the course of each machine cycle. As already mentioned, prior art patty forming machines typically form a single row of patties in each machine cycle. Providing a second row of patty cavities in the mold plate doubles capacity of the machine, with minimal machining. Thus a further advantage of the invention is that food patties may be produced at twice the rate as compared with conventional equipment. Prior art high food patty forming equipment, such as the above-mentioned Formax machines, produce six patties each machine cycle.

The patty cavities are sealed against the atmosphere during the patty forming process. Preferably the lubrication grooves in the mold plate are relocated by one half inch toward the rear of the machine. Preferably, the mill slots are removed in their entirety.

When the mold plate is in the discharge position, knock out cups activated by a cam mechanism descend from above the mold plate to push the formed food patties out of the mold plate and onto, for example, a conveyor belt. Because the food patty forming machine in accordance with the present invention forms multiple rows of food patties at once, the knockout bar and associated knock out cups are modified to dislodge food patties from all rows at once. Thus in the presently preferred embodiment, two rows of knock out cups are activated at once in order to dislodge both rows of patties formed in a single machine cycle.

In order to double the number of patties formed per machine cycle, the distance traveled by the mold plate in each cycle is extended from 9 3/32 inches to 10 3/32. Extension of the stroke length is required because two rows of patty cavities are filled from a single row fill slots. The change in stroke length also requires modification of the drive train used for moving the mold plate during the molding cycle. In particular the length of short arm adjustment slot is increased so that the rear adjustment slot may be positioned one half-inch closer to the rear of the machine. It should be noted that an adjustment slot either not present or not long enough in all food processing machines. In machines lacking the facility for such adjustment, arrow 55 in FIG. 5 indicates the location of an adjustment slot that should be created in the short arm to effectuate this aspect of the invention.

The position of the of the mold plate, and its relationship to the mechanical stroke provided by reciprocating assembly (51) as well as the hydraulic pressure applied to the ram used to extrude food material into the mold and fill plates of the present invention is summarized in Table 1, with the progress of a machine cycle defined in terms of the degrees of offset from top dead center of the crank arm of the reciprocating assembly (51). The timing of stock machines must be modified because two rows of patty cavities are filled an emptied during each machine cycle, as compared with stock machines, in which only one row of patty cavities is filled and emptied per cycle.

At the beginning of a machine cycle, with the mold plate in the discharge position (0 degrees stroke), the mold plate is stopped (“dwell”). Low pressure is applied to the ram. At 56 degrees of stroke, the mold plate is moved backward by a pair of draw a bars under the control of reciprocating assembly (51). At 120 degrees, high pressure is turned on, extruding food material into the patty cavities, and the rear mold plate cavities begin to fill, as the rear patty cavities are drawn across fill plate (10). High pressure remains on at 171 degrees of stroke, as the mold plate is again stopped in dwell, and the front cavities begin to fill. At 220 degrees the both sets of patty cavities stop filling, and the mold plate begins to move toward the discharge position, at the front of the machine. High pressure is shut off as filling of the patty cavities is complete. At 350 degrees, the mold plate stops in dwell, in the discharge position. At 354 degrees, high pressure remains off, and the knock out cups are activated to dislodge the patties formed during the machine cycle.

The invention has been described in terms of certain preferred embodiments. However, the scope of the invention defined not by embodiments used for purposes of illustration, but by the claims appended hereto.

We claim:

1. An improved food patty molding apparatus that forms 12 food patties for each machine cycle, comprising a fill plate with six fill slots therein.

2. An improved food patty molding apparatus comprising a mold plate in which a plurality of rows of patty cavities are formed, wherein each row of patty cavities is oriented parallel to the long dimension of the mold plate.

3. The improved food patty molding apparatus of claim 1 wherein the fill plate replaces a fill plate having a single fill slot.

4. The improved food patty molding apparatus of claim 2, wherein the fill plate with a plurality of rows replaces a fill plate of only a single row.

5. The improved food patty molding apparatus of claim 1, further comprising a plurality of row of patty cavities.

6. The improved food patty molding apparatus of claim 2 comprising 2 rows of patty cavities.

7. The improved fill plate of claim 5, further comprising two rows of patty cavities.

8. The improved fill plate of claim 5, further comprising a fill plate that is extended in length by about one inch from its discharge end to its fill end.

9. The improved fill plate of claim 4 wherein the fill slots are perpendicular to the surface of the fill plate.

10. The food patty molding apparatus of claim 4, wherein the fill slots are oriented at an acute angle with respect to the surface of the fill plate.

11. The food patty molding apparatus of claim 4, wherein the fill slots are perpendicular to the surface of the fill plate.

12. The improved patty forming machine of claim 1, wherein a hydraulic cylinder of 3 ¼ inches diameter replaces one of 4 inch diameter.

13. The improved patty forming machine of claim 1, wherein a separate set of knock out cups dislodge patty cavities from each row of patty cavities.

14. The improved patty forming machine of claim 1, wherein the distance traveled by the mold plate is extended to 10 3/32 inch.

15. The improved patty forming machine of claim 1, wherein forward movement of the front cavities stops during filling, but the rear patty cavities continue forward movement while they are being filled.
